(19) United States
(12) Patent Application Publication
(10) Pub. No.: US 2004/0260741 A1
(43) Pub. Date: Dec. 23, 2004

(54) Method and apparatus for performing modular arithmetic

(75) Inventor: Bernard Plessier, Singapore (SG)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics Asia, Singapore (SG)

(21) Appl. No.: 10/813,927

(22) Filed: Mar. 31, 2004

(30) Foreign Application Priority Data
Apr. 4, 2003 (SG) 200301780-3

(51) Int. Cl. G06F 7/00

(52) U.S. Cl. 708/492

(57) ABSTRACT

An apparatus and method for performing a modular operation S=AB mod N, the apparatus arranged such that the constant J0, which is ordinarily required in order to complete the operation, is not required to be explicitly computed, thus simplifying and speeding up the operation.

### BACKGROUND OF THE INVENTION

1. Field of the Invention

Many electronic interactions require the provision of a certain level of security to ensure that the data contained in a message transfer is difficult to intercept and decode, or it is capable of being verified as being genuine, or both. To achieve these ends, it is possible to encrypt data according to one of many possible schemes. A popular scheme is called public key cryptography (e.g., PGP). Public key cryptography enables a particular message to be encoded according to an individual's private key and a third party's public key—both are long fixed numbers. The message may then be decoded by the third party through use of their private key. In this way, each party may keep their private key secret and thus control who is able to receive and decode any given message.

One of the key elements of encryption systems is the ability to be able to perform modular arithmetic. The basic calculation which is performed may be written as:

S=AB mod N (1)

where A, B and N are large numbers, typically including many hundreds of digits.

Cryptography systems are generally mathematically complex and can pose a high computational overhead on any system which implements them.

2. Description of the Related Art

Prior art systems for performing modular arithmetic make use of Montgomery's theorem, which has been used in many software and hardware implementations of modular arithmetic algorithms. Implementations using Montgomery's theorem are able to compute a value for S without first multiplying A and B and then dividing by N. Most of the hardware implementations rely on an iterative approach which decomposes A into k blocks of p bits to limit the size of the hardware operators required. Further advances have used a serial architecture to further reduce the circuit size. Such architectures are generally based around two serial multipliers, FIFO elements, and the pre-computation of a constant J₀, such that:

J₀.N≡−1mod2^{p} (2)

k and p are both positive integers, and the binary representation of a positive integer X, where X<2^{kp} may be given by:

$$X = {\sum }_{i = 0}^{k - 1} X [ i ] {2}^{i} \qquad ( 3 )$$

where 0≦X[i]<2, i.e., X may be either 0 or 1.

Throughout this specification, square brackets [ ] refer to a particular bit position in a multi-bit word e.g., X[i] refers to the i^{th} bit of word X. Angle brackets <> refer to a particular block of a multi-bit word e.g., X<i> refers to the i^{th} block of word X. Parentheses ( ) refer to the value of a word at a particular iteration of a loop function e.g., X(i) refers to the value of word X at the i^{th} iteration.

A definition for X[j:k], where j>k, is that X is a positive integer having a total length of j+1-k bits, such that X[j] is the MSB and X[k] is the LSB.

The base 2^{p} representation of X is given by:

$$X = {\sum }_{i = 0}^{k - 1} X ⟨ i ⟩ {2}^{pi} \qquad ( 4 )$$

where 0≦X<i><2^{p}

In the following description, it is assumed that N is an odd integer such that 2^{p(k-1)}<N<2^{kp}, and that both A and B are less than N. A p-bit constant, J₀, is thus defined as:

J₀.N<0>≡−1.mod2^{p} (5)

N is the modulus number which is used in all public key cryptography systems. It is defined as the product of two large prime numbers (i.e., >>2) and must therefore be odd.

The prior art hardware implementation of the Montgomery theorem may be described by the following pseudo-code.

| | |
|---|---|
| 1. | procedure MM-BASIC(A,B,N) |
| 2. | S(−1) = 0 |
| 3. | for i=0 to k−1 |
| 4. | T = S(i − 1) + A<i>B |
| 5. | Y₀ = (T.J₀) mod 2^{p} |
| 6. | S(i) = (T + NY₀)/2^{p} |
| 7. | if S(i) ≧ N then S(i) = S(i) − N |
| 8. | end for |

The implementation of this pseudo code in hardware is shown in a simplified form in FIG. 1. The architecture is constructed in serial form so that one bit of the solution is generated for each clock cycle. Such an architecture, as opposed to a parallel one, minimizes the amount of hardware required at the expense of speed.

The circuit of FIG. 1 is arranged to receive five different input signals: A[k] 200; B[t] 205; S(i−1) 210; GE(i−1) 215; and N[t] 220.

Serial Multiplier 110 accepts as inputs, a fixed p-bit word, A<i> produced by register 105, and a one-bit data stream B[t] 205. It then acts to produce the output, (A<i>.B), one bit at a time.

Multiplier 110 is configured internally as shown in FIG. 2. The two inputs are the output 340 of register 105 and B[t] 205. The two inputs 205, 340 are ANDed together in AND gate 300. The result of this operation is fed into Carry Save Adder 310, along with two other inputs. The first of these other inputs is the carry output (C) derived from the fed back output from p-bit register 315. The other input to the Adder is derived from the result output (R) of p-bit register 320 which has been divided by 2 in divider 305. Registers 315, 320 are positioned immediately after the Carry Save Adder 310 and each receives one of the twin outputs produced by the adder.

The Carry Save Adder 310 is arranged to transform a sum of three numbers into a sum of two numbers such that:

2.C+R=X+Y+Z (6)

The Carry Save Adder 310 computes C(t) and R(t) based on the following bitwise Boolean equations.

C(t)=(C(t−1) OR R(t−1)/2) AND (C(t−1) AND B[t].A<i>) AND (R(t−1)/2 AND b[T].A<i>) (7)

R(t)=C(t−1)⊕R[t].A<i> (8)

In a simplified notation:

C(t), R(t)=SERIAL_MULT (B[t].A<i>, C(t−1), R(t−1)) (9)

The procedure MM_BASIC, already shown, may be written in a form which shows the serial operations explicitly:

| | |
|---|---|
| 1. | procedure MM-SERIAL(A, B, N) |
| 2. | S(−1) = 0 |
| 3. | GE(−1) = 0 |
| 4. | for i=0 to k−1 |
| 5. | #computation of Y₀ |
| 6. | for t= 0 to p−1 |
| 7. | C_{S1}(t), R_{S1}(t) = SERIAL_SUB(C_{S1}(t−1), GE(i−1) . N[t], |
| | S(i−1 )[t]) |
| 8. | C_{M1}(t), R_{M1}(t) = SERIAL_MULT(B[t] . A<i>, C_{M1}(t−1), |
| | R_{M1}(t−1)) |
| 9. | C_{A1}(t), R_{A1}(t) = SERIAL_ADD(C_{A1}(t−1), R_{M1}(t)[0], R_{S1}(t)) |
| 10. | C_{M2}(t), R_{M2}(t) = SERIAL_MULT(R_{A1}(t) . J₀, C_{M2}(t−1), |
| | R_{M2}(t−1)) |
| 11. | Y₀[t] = R_{M2}(t) |
| 12. | end for |
| 13. | # mail loop: computation of S(i) |
| 14. | for t = 0 to kp + p−1 |
| 15. | C_{S1}(t), R_{S1}(t) = SERIAL_SUB(C_{S1}(t−1), GE(i−1) . N[t], |
| | S(i−1)[t]) |
| 16. | C_{M1}(t), R_{M1}(t) = SERIAL_MULT(B[t] . A<i>, C_{M1}(t−1), |
| | R_{M1}(t−1)) |
| 17. | C_{A1}(t), R_{A1}(t) = SERIAL_ADD(C_{A1}(t−1), R_{M1}(t)[0], R_{S1}(t)) |
| 18. | C_{M2}(t), R_{M2}(t) = SERIAL_MULT(R_{A1}(t) . J₀, C_{M2}(t−1), |
| | R_{M2}(t−1)) |
| 19. | C_{A2}(t), R_{A2}(t) = SERIAL_ADD(C_{A1}(t−1), R_{M2}(t)[0], R_{A1}(t)) |
| 20. | S(i)[t−p] = R_{A2}(t) |
| 21. | SGE(t) = SERIAL_GE(SGE(t−1), N[t−p], S(i)[t−p]) |
| 22. | end for |
| 23. | GE(i) = SGE(kp+p−1) |
| 24. | end for |

The total number of clock cycles required to compute the result according to the above scheme is k(kp+2p).

### BRIEF SUMMARY OF THE INVENTION

In accordance with one embodiment of the present invention, an apparatus is provided that includes inputs A, B and N, and an output S, said apparatus being arranged to perform a modular operation, S=A.B mod N, the apparatus including a 2-stage Carry Save Adder (2-CSA) and a 1-stage Carry Save Adder (1-CSA), the 2-CSA being arranged to receive 5 input signals: U₀, being the partial product of N and Y₀; U₁, being the subtraction of a previous version of S and U₆ wherein U₆ is either N or 0 depending on the value of the comparison between the result of the previous iteration and N; U₂, being the partial product of B with the current version of A; U₃, being S/2; and U₄, being the carry output of the 1-CSA; where result and carry outputs of the 2-CSA form two of three inputs to the 1-CSA, wherein the result (R) output of the 1-CSA is the desired result (S), and the third input to the 1-CSA is a compensation signal arranged to allow S to be calculated without knowing the constant J₀, where J₀N<0>=−1. mod 2^{p}, where p is a block length into which A is sub-divided.

In a second broad form, an embodiment of the present invention provides An iterative method of performing a modular operation of S=A.B mod N, where A, B and N are encoded as multi-bit digital words, including the following steps: a) setting S(−1) to 0, and i to 0; b) setting S(i) to (S(i−1)+A<i>B+NY₀)/2^{p}; c) setting S(i) to (S(i)−N) if S(i)≧N; d) repeating steps b) and c) k times, wherein: i is a loop counter; k is a number of blocks of p bits length into which A is divided; Y₀=((T.J₀)mod 2^{p}); J₀N=−1 mod2^{p}; and Y₀ is calculated one bit at a time, based on the fact that (T+NY₀) is a multiple of 2^{p}.

In accordance with another embodiment of the invention, an apparatus for performing modular arithmetic is provided, the apparatus includes a first AND gate configured to receive first and second inputs and to generate a first output; a second AND gate configured to receive third and fourth inputs and to generate a second output; a divider configured to generate a third output; a first carry-save adder configured to receive as inputs the first output from the first AND gate, the second output from the second AND gate, and the third output from the divider and to generate fourth and fifth outputs; a second carry-save adder configured to receive the combination of the fourth output and a fifth input as one input and to receive the fifth output as a second input and to generate a carry output that is fed back into a third input of the second carry-save adder and to generate a result output that is an input to the divider and the desired result.

In accordance with yet a further embodiment of the invention, an apparatus for performing modular arithmetic is provided, the apparatus having inputs A, B, and N and an output S; a first carry-save adder configured to receive five input signals that include: U₀, the partial product of N and Y₀, where Y₀ equal ((T.J₀) mod 2^{p}); U₁, the subtraction of a previous version of S and U₆, wherein U₆ is one of N or 0 depending on the value of a comparison between a result of a previous iteration and N; U₂, a partial product of input B and a current version of input A; U₃, the result of S/2; and U₄, a carry output of a second carry-save adder; the first carry-save adder configured to generate a result output and a carry output; the second carry-save adder configured to receive the result output and the carry output from the first carry-save adder and to receive a compensation signal as a third input and to generate a desired result and the carry output U₄; and wherein J₀N<0>=−1. mod 2^{p}, where p is a block length into which A is sub-divided.

Other features and benefits of the invention will become apparent in the following description of various embodiments of the invention.

### BRIEF DESCRIPTION OF THE DRAWINGS

For a better understanding of the present invention and to understand how the same may be brought into effect, the invention will now be described by way of example only, with reference to the appended drawings in which:

FIG. 1 shows a simplified prior art circuit for implementing modular arithmetic according to Montgomery's theorem;

FIG. 2 shows a prior art serial/parallel multiplier or carry save adder;

FIG. 3 shows a merged multiplier as used in embodiments of the invention; and

FIG. 4 shows a hardware implementation according to an embodiment of the invention.

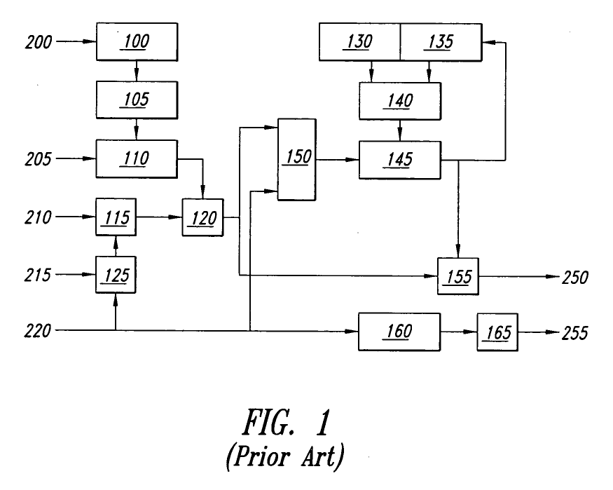

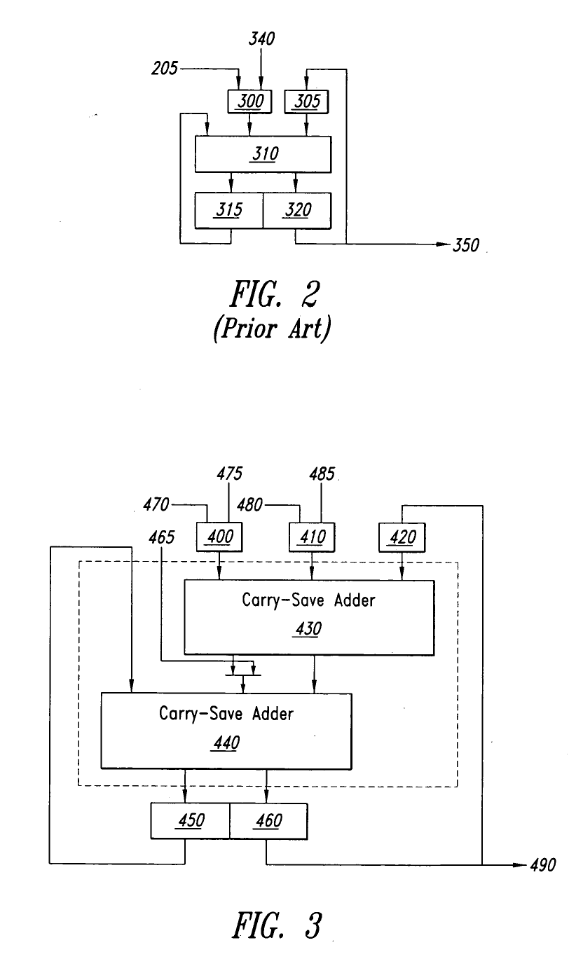

### DETAILED DESCRIPTION OF THE INVENTION

The present invention retains a serial architecture to accomplish the calculation, but embodiments of the inventions do not require pre-knowledge of the constant, J₀. Embodiments of the invention calculate Y₀=((T.J₀)mod 2^{p}) one bit at a time, based on the fact that (T+NY₀) must be a multiple of 2^{p}. In this way, the complex mathematical functions required to pre-compute J₀ can be dispensed with.

With this implicit knowledge, the procedure MM-BASIC described previously, may now be written as MM-SIMPLE:

| | |
|---|---|
| 1. | procedure MM-SIMPLE(A, B, N) |
| 2. | S(−1) = 0 |
| 3. | for i = 0 to k-1 |

| | |
|---|---|
| 4. | S(i) = (S(i-1) + A<i>B + NY₀)/2^{p} |
| 5. | if S(i) ≧ N then S(i) = S(i) - N |

| | |
|---|---|
| 6. | end for |

The above serial implementation of MM-SIMPLE is more efficient than the prior art implementation of MM-BASIC that has two multipliers required instead of the single multiplier in the disclosed embodiments of the invention. The gain, in terms of fewer components, is a total of 2p registers plus the two serial adders 120 and 155. The removal of the need for these components removes a significant amount of circuitry, and thus the resulting architecture requires less space and consumes less power to achieve the same result. This design also calculates the result in fewer clock cycles.

FIG. 3 shows the resultant hardware implementation which may be used to perform the steps of procedure MM-SIMPLE presented above. As shown therein, an apparatus for performing modular arithmetic is provided that includes a first AND gate 400 receiving inputs 470 and 475 and generating a first output, a second AND gate 410 receiving as inputs 480 and 485 and generating a second output, and a divider 420 generating a cleared output. A first carry-save adder 430 receives on a first input the first output of the first AND gate 400, on a second input the second output of the second AND gate 410, and on a third input an output of the divider 420, and generates therefrom a first output and a second output that are received as first and second inputs of a second carry-save adder 440. It is to be noted that the first output of the first carry-save adder 430 is combined with a fifth input 465 prior to being received at the second carry-save adder 440. The second carry-save adder 440 generates on a first output a carry out that is received at a first register 450, the output of which becomes a third input to the second carry-save adder 440. A second output of the carry-save adder 440 is received at a second register 460 and becomes the desired result 490 that is also the input to the divider 420.

Y₀ is computed bit by bit during the first p cycles of the loop, starting at line 15 of the procedure MM-SERIAL. Assuming that at cycle q<p, the bits 0, 1, . . . q−1 have already been computed, leaving only bit q to be discovered.

According to embodiments of the present invention, if, at cycle q, the LSB of the 2-stage Carry Save Adder shown in FIG. 3 is ‘1’, then N[q:0] is added to the intermediate result, and Y₀[q]=1.

This may be proved as follows. At the q^{th} step, the intermediate values from the first Carry Save Adder may be given as

$$\begin{matrix}S = 2 C + R & ( 10 ) \\ = ( A ⟨ i ⟩ . B [ q : 0 ] + {Y}_{0} [ q - 1 : 0 ] . N [ q : 0 ] + S ⟨ i - 1 ⟩ [ q : 0 ] ) / {2}^{q} & ( 11 )\end{matrix}$$

Assuming that the q^{th} bit of Y₀ is a ‘1’, then the above equation may be re-written as:

$$\begin{matrix}{S}^{′} = ( A ⟨ i ⟩ . B [ q : 0 ] + ( {2}^{q} + {Y}_{0} [ q - 1 : 0 ] ) . N [ q : 0 ] + S ⟨ i - 1 ⟩ [ q : 0 ] ) / {2}^{q} & ( 12 ) \\ = S + N [ q : 0 ] & ( 13 )\end{matrix}$$

As the LSB of N is always 1, since it is a large prime number and, therefore, odd, then from the above equations, it can be seen that the LSBs of S and S′ are always inverted. Therefore, it is possible to guarantee that the LSB of the result is 0 in the first p steps by choosing either S or S′. The choice of S′ implies that the q^{th} bit of Y₀ must be forced to equal 1.

The above step is repeated at each cycle q<p, so that at the end all bits of Y₀ are discovered.

The procedure, MM-SERIAL-SIMPLE shown below is a pseudo-code implementation of an embodiment of the present invention, and is a version of the previously presented MM-SERIAL adapted according to the above results.

| | |
|---|---|
| 1. | procedure MM-SERIAL-SIMPLE(A, B, N) |
| 2. | S(−1) = 0 |
| 3. | GE(−1) = 0 |
| 4. | for i = 0 to k−1 |
| 5. | # main loop: computation of S(i) |
| 6. | for t = 0 to kp+p−1 |
| 7. | C_{S1}(t), R_{S1}(t) = SERIAL_SUB(C_{S1}(t−1), GE(i−1) . N[t], |
| | S(i−1)[t]) |
| 8. | Cᵢₙₜ, Rᵢₙₜ = 2-STAGE_CSA(B[t] . A<i>, C_{M}(t−1), R_{M}(t−1)/2, |
| | N[t] . Y₀) |
| 9. | if t < p and Rᵢₙₜ[0] = 1 then |
| 10. | C_{M}(t), R_{M}(t) = CSA(N[t:0], Cᵢₙₜ, Rᵢₙₜ) |
| 11. | Y₀[f] = 1 |
| 12. | else |
| 13. | C_{M}(t), R_{M}(t) = Cᵢₙₜ, Rᵢₙₜ |
| 14. | end if |
| 15. | S(i)[t−p] = R_{M}(t)[0] |
| 16. | SGE(t) = SERIAL_GE(SGE(t−1), N[t−p], S(i)[t−p]) |
| 17. | end for |
| 18. | GE(i) = SGE(kp+p−1) |
| 19. | end for |

The conditional statement at line 9 of the above procedure may be considered to trigger a compensation event which, if t<p and Rᵢₙₜ[0]=1, causes the value of register 525 N_{del} to be applied to the input of the 1-stage CSA (1-CSA) 540. If the condition is not satisfied, then the C and R outputs of the 2-stage CSA (2-CSA) 520 merely feed straight into the 1-CSA and no compensation is performed.

It is the addition of the compensation function that directly removes the need to explicitly compute J₀.

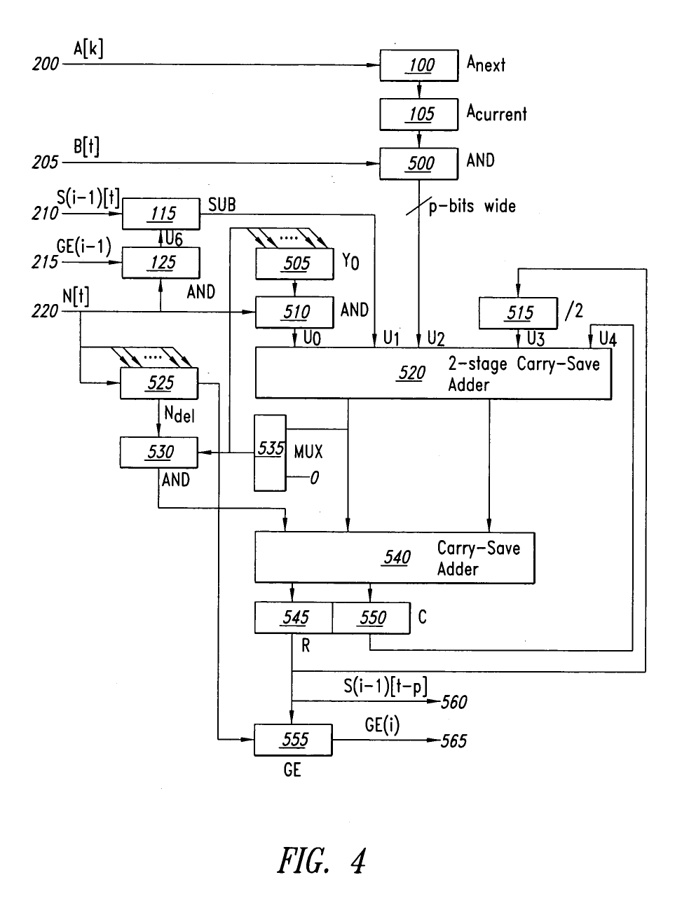

In FIG. 4, the compensation function is implemented by register 525, AND gate 530, MUX 535. The MUX 535 effectively performs the conditional IF statement of line 9 of MM-SERIAL-SIMPLE, and if Rᵢₙₜ[0] is equal to 1, then the contents of register 525 is applied to 1-CSA 540.

The above procedure (MM-SERIAL-SIMPLE) is further explained in the procedure below (MM-SERIAL-SIMPLE_enhanced), which includes further details on selected ones of the internal signal nets.

These internal nets are labelled from U₀ to U₈ and directly correspond with selected internal nets shown in FIG. 4.

| | |
|---|---|
| 1. | procedure MM-SERIAL-SIMPLE_enhanced(A, B, N) |
| 2. | S(−1) = 0 |
| 3. | GE(−1) = 0 |
| 4. | Aₙₑₓₜ = A[p−1:0] |
| 5. | for i=0 to k−1 |
| 6. | # main loop: computation of S(i) |
| 7. | N_{del} = 0 |
| 8. | Y₀ = 0 |
| 9. | R = 0 |
| 10. | C = 0 |
| 11. | A_{current} = Aₙₑₓₜ |
| 12. | Aₙₑₓₜ = A[(i+1)(p−1):(i+1 )p] |
| 13. | for t = 0 to kp+p−1 |
| 14. | U₀ = AND2(N[t], Y₀) |
| 15. | U₆ = AND1(GE(i−1), N[t]) |
| 16. | U₁ = SUB1(U₆, S(i−1[t]) |
| 17. | U₂ = AND3(B[t], A_{current}) |
| 18. | U₃ = R/2 |
| 19. | U₄ = C |
| 20. | Cᵢₙₜ, Rᵢₙₜ = 2-STAGE-CSA(U₀, U₁, U₂, U₃, U₄) |
| 21. | U₇ = MUX(Rᵢₙₜ[0],0) |
| 22. | U₅ = AND4(U₇, N_{del}) |
| 23. | if t < p then |
| 24. | Y₀[t] = U₇ |
| 25. | N_{del}[t] = N[t] |
| 26. | U8=0 |
| 27. | else |
| 28. | # N_{del} acts as a shift register |
| 29. | U₈ = N_{del}[0] |
| 30. | N_{del} = N_{del}/2 |
| 31. | N_{del}[p−1] = N[t] |
| 32. | endif |
| 33. | C,R = CSA(U₅, Cᵢₙₜ, Rᵢₙₜ) |
| 34. | S(i)[t] = R[0] |
| 35. | SGE(t) = GE(U₈, R[0]) |
| 36. | end for |
| 37. | GE(i) = SGE(kp+p−1) |
| 38. | end for |

As an example, presented below are details of how an embodiment of the invention operates on some sample input data. The following inputs are provided in 32-bit format:

A=C7197F0E

B=CCEFBAE4_{—}77AF9EE5_{—}848D8AE6

N=D077EC53_F4AA27A4_D7816723

The result of the Montgomery multiplication of A by B is given by (AB+NY₀)/2^{p}. Before the computation starts, the registers of the multiplier are initialized as follows.

N₀=00000003

Y₀=00000000

RC=0_{—}00000000

B[t]=6

N[t]=3

For the sake of simplicity, the registers R and C have been summed into register RC, and the computation is performed 4 bits (a nibble) at the time, thus setting p=4.

1. Computation of the intermediate results, based on the partial products

| | |
|---|---|
| N[t].Y0 = | 0_00000000 |
| +B[t].A = | 4_AA98FA54 |
| +RC/16 = | 0_00000000 |
| =Intermediate = | 4_AA98FA54 |

2. Find the first 4 bits of compensation value (Z) such that the 4 LSBs of Intermediate+Z.N₀ are all zero.

Z=4

3. Add the partial product Z.N₀ to Intermediate

| | |
|---|---|
| Intermediate = | 4_AA98FA54 |
| +Z.N₀ = | 0_0000000C |
| =RC = | 4_AA98FA60 |

4. Update the registers with- the new values and restart the cycle

N₀=00000023 Y₀=00000004 RC=4_AA98FA60 B[t]=EN [t]=2

1. Computation of the intermediate results, based on the partial products

| | |
|---|---|
| N[t].Y0 = | 0_0000008C |
| +B[t].A = | A_E364F2C4 |
| +RC/16 = | 0_4AA98FA6 |
| =Intermediate = | B_2E0E8272 |

2. Find first 4 bits of compensation (Z) such that the 4 Isb of Intermediate+Z.N₀ are all zero.

Z=A

3. Add the partial product Z.N₀ to Intermediate

| | |
|---|---|
| Intermediate = | B_2E0E8272 |
| +Z.N₀ = | 0_0000015E |
| =RC = | B_2E0E83D0 |

4. Update the registers with the new values and restart the cycle

N₀=00000723Y₀=000000A4RC=B_{—}2E0E83D0B[t]=AN[t]=7

1. Computation of the intermediate results, based on the partial products

| | |
|---|---|
| N[t].Y0 = | 0_0000047C |
| +B[t].A = | 7_C6FEF68C |
| +RC/16 = | 0_B2E0E83D |
| =Intermediate = | 8_79DFE345 |

2. Find first 4 bits of compensation (Z) such that the 4 Isb of Intermediate+Z.N0 are all zero.

Z=9

3. Add the partial product Z.N₀ to Intermediate

| | |
|---|---|
| Intermediate = | 8_79DFE345 |
| +Z.N₀ = | 0_0000403B |
| =SUM₂ = | 8_79E02380 |

4. Update the registers with the new values and restart the cycle

N₀=00006723 Y₀=000009A4.RC=8_{—}79E02380 B[t]=8N [t]=6

This process is repeated until all the bits of Y₀ are discovered. At this stage, the compensation phase is no longer needed so the computation iterates over the remaining bits of B and N. The step by step result at each phase is given by the following table:

| Cycle | N₀ | Y₀ | RC | B[t] | N[t] |
|---|---|---|---|---|---|
| 0 | XXXXXXXX | XXXXXXXX | XXXXXXXXXX | X | X |
| 1 | 00000003 | 00000000 | 0000000000 | 6 | 3 |
| 2 | 00000023 | 00000004 | 04AA98FA60 | E | 2 |
| 3 | 00000723 | 000000A4 | 0B2E0E83D0 | A | 7 |
| 4 | 00006723 | 000009A4 | 0879E02380 | 8 | 6 |
| 5 | 00016723 | 000009A4 | 06C06A3480 | D | 1 |
| 6 | 00816723 | 000A09A4 | 0A88602800 | 8 | 8 |
| 7 | 07816723 | 000A09A4 | 06E1A24810 | 4 | 7 |
| 8 | D7816723 | 090A09A4 | 03CE530470 | 8 | D |
| 9 | D7816723 | 790A09A4 | 0CCFBD7800 | 5 | 4 |
| 10 | 4D781672 | 790A09A4 | 0694A37956 | E | A |
| 11 | A4D78167 | 790A09A4 | 1007138AC1 | E | 7 |
| 12 | 7A4D7816 | 790A09A4 | 0F331C6EEC | 9 | 2 |
| 13 | 27A4D781 | 790A09A4 | 08E52B51B4 | F | A |
| 14 | A27A4D78 | 790A09A4 | 10F3358755 | A | A |
| 15 | AA27A4D7 | 790A09A4 | 0D9096AF69 | 7 | 4 |
| 16 | 4AA27A4D | 790A09A4 | 082EE40AE8 | 7 | F |
| 17 | F4AA27A4 | 790A09A4 | 0D0C374AAC | 4 | 3 |
| 18 | 3F4AA27A | 790A09A4 | 0558478DCE | E | 5 |
| 19 | 53F4AA27 | 790A09A4 | 0D961B9BD4 | A | C |
| 20 | C53F4AA2 | 790A09A4 | 0E4CD923F9 | B | E |
| 21 | EC53F4AA | 790A09A4 | 1011728ED1 | F | 7 |
| 22 | 7EC53F4A | 790A09A4 | 0FFADBDE3B | E | 7 |
| 23 | 77EC53F4 | 790A09A4 | 0F3258F423 | C | 0 |
| 24 | 077EC53F | 790A09A4 | 0A485783EA | C | D |
| 25 | D077EC53 | 790A09A4 | 101F39EA3A | 0 | 0 |
| 26 | 0D077EC5 | 790A09A4 | 0101F39EA3 | 0 | 0 |
| 27 | 00D077EC | 790A09A4 | 00101F39EA | 0 | 0 |
| 28 | 000D077E | 790A09A4 | 000101F39E | 0 | 0 |
| 29 | 0000D077 | 790A09A4 | 0000101F39 | 0 | 0 |
| 30 | 00000D07 | 790A09A4 | 00000101F3 | 0 | 0 |
| 31 | 000000D0 | 790A09A4 | 000000101F | 0 | 0 |
| 32 | 0000000D | 790A09A4 | 0000000101 | 0 | 0 |
| 33 | 00000000 | 790A09A4 | 0000000010 | 0 | 0 |
| 34 | 00000000 | 790A09A4 | 0000000001 | 0 | 0 |

Notice that the serial output result can be read directly as the right most nibble of the RC column. It is also interesting to notice the shifting pattern of N₀. From cycle 1 to 8, the register behavior is comparable to a stack, where the nibble are pushed from the left. From cycle 9 onward, the register behaves as a right shift register. The output of this register shall be used as the input of a comparator which detects if the results is greater or equal to N.

Y=790A09A4 RESULT=1_{—}01F39EA3_AA38194E_C8954C16_{—}00000000

In the light of the foregoing description, it will be clear to the skilled man that various modifications may be made within the scope of the invention.

The present invention includes any novel feature or combination of features disclosed herein either explicitly or any generalization thereof irrespective of whether or not it relates to the claimed invention or mitigates any or all of the problems addressed.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An apparatus, comprising:
inputs A, B and N, and an output S, the apparatus arranged to perform a modular operation, S=A.B mod N, the apparatus including a 2-stage Carry-Save Adder (2-CSA) and a 1-stage Carry-Save Adder (1-CSA), the 2-CSA arranged to receive 5 input signals:
U₀, being the partial product of N and Y₀;
U₁, being the subtraction of a previous version of S and U₆ wherein U₆ is either N or 0 depending on the value of the comparison between the result of the previous iteration and N;
U₂, being the partial product of B with the current version of A;
U₃, being S/2; and
U₄, being the carry output of the 1-CSA;
where result and carry outputs of the 2-CSA form two of three inputs to the 1-CSA, wherein the result (R) output of the 1-CSA is the desired result (S), and the third input to the 1-CSA is a compensation signal arranged to allow S to be calculated without knowing the constant J₀, where J₀N<0>=−1. mod 2^{p}, where p is a block length into which A is sub-divided.

2. The apparatus of claim 1 wherein the compensation signal is generated to equal a delayed version of N in the event that t<p and the Result (R) output of the 2-CSA equals ‘1’.

3. The apparatus of claim 1 wherein the 2-CSA includes two 1-CSA arranged in series.

4. The apparatus of claim 1 wherein while processing bits 0 to p-1, register Y₀ is arranged such that the LSB of the Result (R) output of the 1-CSA is always ‘0’.

5. The apparatus of claim 1 wherein the apparatus is arranged to take the form of a custom integrated circuit.

6. The apparatus of claim 5 wherein the custom integrated circuit includes a digital signal processor (DSP).

7. An iterative method of performing a modular operation of S=A.B mod N, where A, B and N are encoded as multi-bit digital words, including the following steps:
a) setting S(−1) to 0, and i to 0;
b) setting S(i) to (S(i−1)+A<i>B+NY₀)/2^{p};
c) setting S(i) to (S(i)−N) if S(i)≧N; and
d) repeating steps b) and c) k times;
wherein:
i is a loop counter;
k is a number of blocks of p bits length into which A is divided;
Y₀=((T.J₀) mod 2^{p});
J₀N=−1mod2^{p}; and
Y₀ is calculated one bit at a time, based on the fact that (T+NY₀) is a multiple of 2^{p}.

8. An apparatus for performing modular arithmetic, the apparatus comprising:
a first AND gate configured to receive first and second inputs and to generate a first output;
a second AND gate configured to receive third and fourth inputs and to generate a second output;
a divider configured to generate a third output;
a first carry-save adder configured to receive as inputs the first output from the first AND gate, the second output from the second AND gate, and the third output from the divider and to generate fourth and fifth outputs; and
a second carry-save adder configured to receive the combination of the fourth output and a fifth input as one input and to receive the fifth output as a second input and to generate a carry output that is fed back into a third input of the second carry-save adder and to generate a result output that is an input to the divider and the desired result.

9. The apparatus of claim 8, comprising a first register having the carry output of the second carry-save adder as an input and its output feeding back to the third input of the carry-save adder; and a second register receiving as an input the result and generating as an output the desired result that is fed back to the input of the divider and is the output of the apparatus.

10. The apparatus of claim 9, wherein the apparatus is configured to perform a modular operation of S=A.B mod N, where A, B and N are encoded as multi-bit digital words, including the following steps:
a) setting S(−1) to 0, and i to 0;
b) setting S(i) to (S(i−1)+A<i>B+NY₀)/2^{p};
c) setting S(i) to (S(i)−N) if S(i)≧N; and
d) repeating steps b) and c) k times;
wherein:
i is a loop counter;
k is a number of blocks of p bits length into which A is divided;
Y₀=((T.J₀)mod 2^{p});
J₀N=−1mod2^{p}; and
Y₀ is calculated one bit at a time, based on the fact that (T+NY₀) is a multiple of 2ₚ.

11. The apparatus of claim 10 wherein N is a prime number.

12. An apparatus for performing modular arithmetic, the apparatus comprising:
inputs A, B, and N, and an output S;
a first carry-save adder configured to receive five input signals, comprising:
U₀, the partial product of N and Y₀, where Y₀ equal ((T.J₀)mod 2^{p});
U₁, the subtraction of a previous version of S and U₆, wherein U₆ is one of N or 0 depending on the value of a comparison between a result of a previous iteration and N;
U₂, a partial product of input B and a current version of input A;
U₃, the result of S/2; and
U₄, a carry output of a second carry-save adder;
the first carry-save adder configured to generate a result output and a carry output;
the second carry-save adder configured to receive the result output and the carry output from the first carry-save adder and to receive a compensation signal as a third input and to generate a desired result and the carry output U₄; and
wherein J₀N<0>=−1. mod 2^{p}, where p is a block length into which A is sub-divided.

13. The apparatus of claim 12 wherein the first carry-save adder is a two-stage carry-save adder.

14. The apparatus of claim 12 wherein the first carry-save adder comprises two one-stage carry-save adders arranged in series.

15. The apparatus of claim 12, comprising a register, an AND gate, and a multiplier configured to implement the compensation function in the event t<p and the result output of the second carry-save adder=1 the value N_{del} of the register is applied to the third input of the second carry-save adder, and when the condition is not satisfied, no compensation value is provided to the third input of the second carry-save adder.
